(19) United States
(12) Patent Application Publication
(10) Pub. No.: US 2017/0191647 A1
(43) Pub. Date: Jul. 6, 2017

(54) Touch Sensitive Lighting Device

(71) Applicant: Concavex Plastic Works Limited, Hong Kong (CN)

(72) Inventor: Shiu-fai JIM, Hong Kong (HK)

(21) Appl. No.: 14/986,734

(22) Filed: Jan. 4, 2016

(51) Int. Cl. F21V 23/04; G02B 25/02; G02B 25/00; F21V 23/00

(52) U.S. Cl. CPC F21V 23/0485; F21V 23/003; G02B 25/02; G02B 25/002; F21Y 2115/10

(57) ABSTRACT

A touch sensitive lighting device and method of controlling thereof. Particularly, the application provides a touch sensitive lighting device which is characterized in having a touch sensitive contact point for operating a lighting source of the touch sensitive lighting device with a single finger of a human being. More particularly, the touch sensitive lighting device comprising of a housing for the touch sensitive lighting device; the lighting source of the touch sensitive lighting device for illumination; a power source for providing power to the lighting source for the touch sensitive lighting device for illumination; the touch sensitive contact point for controlling the lighting source of the touch sensitive lighting device; a circuit board includes circuitry for controlling the lighting source and the power source of the touch sensitive lighting device; and a magnifier lens.

### FIELD OF THE INVENTION

The present application generally relates to the field of hand held lighting devices. Particularly, the application provides a touch sensitive lighting device and method of controlling thereof. More particularly, the application provides a touch sensitive lighting device which can be operated with a touch sensitive single contact point.

### BACKGROUND

In recent times hand held lighting devices have been preferred over conventional battery powered oversized torches. Small hand held lighting devices are easy to carry and pretty fast in operation. With the growing demand and operational level accuracy and capabilities; hand held lighting devices have evolved technically in a shorter span of time. Switching mechanism of any such lighting device is considered to be one of the aspects where the modern lighting device manufacturers have consistently focused. Traditional switching mechanisms essentially require triggering of one or the other moving mechanical part through on-off switch. With the advent of technology, varieties of switching mechanisms have evolved. Amongst others, sensor switch are considered technically advanced solution for operating lighting devices.

Prior art literature illustrate sensor switch solutions for lighting devices wherein more than one fingers are required to turn on or off the lighting device. Prior art only provides solution wherein triggering of one or the other mechanical part movement is essentially required to control on-off mechanism of said lighting device.

Thus, in the light of the above mentioned background discussion, it is evident that, there is a need for a touch sensitive lighting device which can be operated with a touch sensitive single contact point operated using only one finger of a human being. There is also a need for a touch sensitive lighting device which could eliminate the need of triggering of one or the other mechanical part movement for controlling on-off mechanism of said lighting device. A touch sensitive lighting device and method of controlling thereof is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a touch sensitive lighting device and method of controlling thereof.

Another objective is to provide a touch sensitive lighting device which could eliminate the need of triggering of one or the other mechanical part movement for controlling on-off mechanism of said lighting device.

In an embodiment of the present invention, a touch sensitive lighting device (100) is provided. The touch sensitive lighting device (100) is characterized in having a touch sensitive contact point (110) for operating a lighting source (106) of the touch sensitive lighting device (100) with a single finger of a human being. The touch sensitive lighting device (100) comprising a housing for the touch sensitive lighting device (100); wherein said housing further comprising a fixed member (102) and a removably attached member (104); the lighting source (106) of the touch sensitive lighting device (100) for illumination; a power source (108) of the touch sensitive lighting device (100) for providing power to the lighting source (106) for the touch sensitive lighting device (100) for illumination; the touch sensitive contact point (110) for controlling the lighting source (106) of the touch sensitive lighting device (100); a circuit board (112) includes circuitry for controlling the lighting source (106) and the power source (108) of the touch sensitive lighting device (100); and a magnifier lens (114).

In an embodiment of the present invention, a method of controlling a touch sensitive lighting device (100) is provided. The method of controlling a touch sensitive lighting device (100) is comprising of touching a touch sensitive contact point (110) of the touch sensitive lighting device (100) by a single finger of a human being; actuating circuitry of a circuit board (112); utilizing a power source (108) of the touch sensitive lighting device (100); switching on a lighting source (106) of the touch sensitive lighting device (100) for illumination; releasing said touch sensitive contact point (110) of the touch sensitive lighting device (100) thereby switching off the lighting source (106) of the touch sensitive lighting device (100).

The above said apparatus and method is provided for a touch sensitive lighting device and method of controlling thereof but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a side view of a touch sensitive lighting device with a removably attached member of housing for the touch sensitive lighting device.

FIG. 2: shows a perspective view of a touch sensitive lighting device with a removably attached member of housing for the touch sensitive lighting device.

FIG. 3: shows a side view of a touch sensitive lighting device without a removably attached member of housing for the touch sensitive lighting device.

FIG. 4: shows a perspective view of a touch sensitive lighting device without a removably attached member of housing for the touch sensitive lighting device.

FIG. 5: shows a circuit diagram of a circuit board of the touch sensitive lighting device.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In an embodiment of the present invention, a touch sensitive lighting device (100) is provided. The touch sensitive lighting device (100) is characterized in having a touch sensitive contact point (110) for operating a lighting source (106) of the touch sensitive lighting device (100) with a single finger of a human being. The touch sensitive lighting device (100) comprising a housing for the touch sensitive lighting device (100); wherein said housing further comprising a fixed member (102) and a removably attached member (104); the lighting source (106) of the touch sensitive lighting device (100) for illumination; a power source (108) of the touch sensitive lighting device (100) for providing power to the lighting source (106) for the touch sensitive lighting device (100) for illumination; the touch sensitive contact point (110) for controlling the lighting source (106) of the touch sensitive lighting device (100); a circuit board (112) includes circuitry for controlling the lighting source (106) and the power source (108) of the touch sensitive lighting device (100); and a magnifier lens (114).

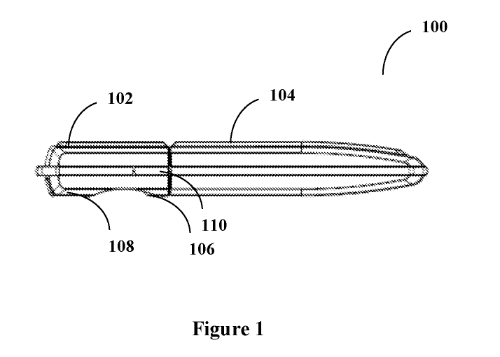

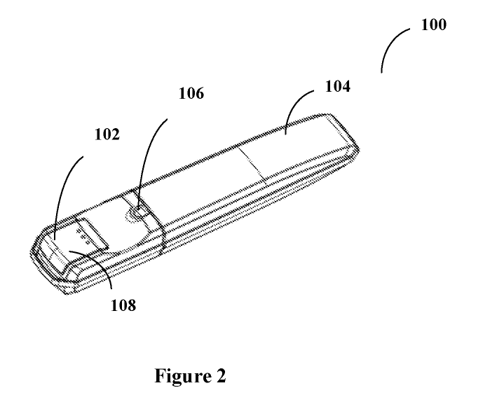

Referring to FIG. 1 is a side view of a touch sensitive lighting device with a removably attached member of housing for the touch sensitive lighting device and FIG. 2 is a perspective view of a touch sensitive lighting device with a removably attached member of housing for the touch sensitive lighting device.

In another embodiment of the present invention, the touch sensitive lighting device (100) comprises of the housing for the touch sensitive lighting device (100). The housing of the touch sensitive lighting device (100) further comprises the fixed member (102) and the removably attached member (104).

In another embodiment of the present invention, the lighting source (106) of the touch sensitive lighting device (100) for is provided for illumination. The lighting source (106) of the touch sensitive lighting device (100) is housed on the fixed member (102) of the housing for the touch sensitive lighting device (100). The lighting source (106) of the touch sensitive lighting source (100) is a plurality of Light Emitting Diode (LED).

In another embodiment of the present invention, the power source (108) of the touch sensitive lighting device (100) is provided for powering the lighting source (106) for the touch sensitive lighting device (100) for illumination. The power source (108) of the touch sensitive lighting device (100) is housed in the fixed member (102) of the housing for the touch sensitive lighting device (100).

In another embodiment of the present invention, the touch sensitive contact point (110) (not shown in FIG. 2) is provided for controlling the lighting source (106) of the touch sensitive lighting device (100). The touch sensitive contact point (110) (not shown in FIG. 2) is comprising of a conductive material and terminally expended by a cosmetic chrome plat on the periphery of the fixed member (102) of the housing for the touch sensitive lighting device (100). The touch sensitive contact point (110) (not shown in FIG. 2) switches on the lighting source (106) of the touch sensitive lighting device (100) when the touch sensitive contact point (110) (not shown in FIG. 2) is touched by a single finger of a human being. The touch sensitive contact point (110) (not shown in FIG. 2) switches off the lighting source (106) of the touch sensitive lighting device (100) when the touch sensitive contact point (110) (not shown in FIG. 2) is released by a single finger of a human being. The touch sensitive contact point (110) (not shown in FIG. 2) of the touch sensitive lighting device (100) is localized on the fixed member (102) of the housing for the touch sensitive lighting device (100).

In another embodiment of the present invention, the circuit board (112) (not shown in FIG. 1 and FIG. 2) including circuitry is provided for controlling the lighting source (106) and the power source (108) of the touch sensitive lighting device (100). The circuit board (112) (not shown in FIG. 1 and FIG. 2) including circuitry for controlling the lighting source (106) and the power source (108) of the touch sensitive lighting device (100) is housed in the fixed member (102) of the housing for the touch sensitive lighting device (100).

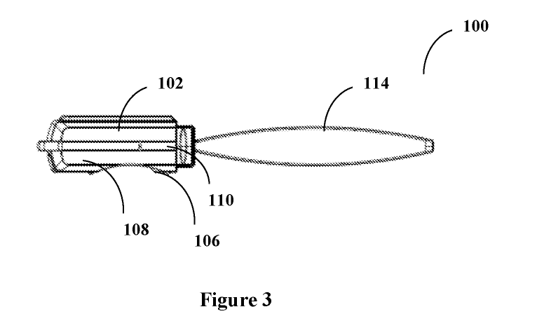

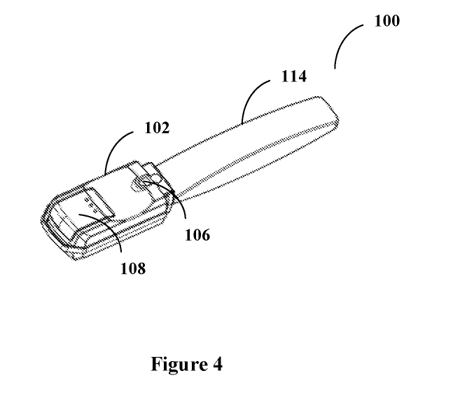

Referring to FIG. 3 is a side view of a touch sensitive lighting device without a removably attached member of housing for the touch sensitive lighting device and FIG. 4 is a perspective view of a touch sensitive lighting device without a removably attached member of housing for the touch sensitive lighting device.

In another embodiment of the present invention, the touch sensitive lighting device (100) comprises of the housing for the touch sensitive lighting device (100). The housing of the touch sensitive lighting device (100) further comprises the fixed member (102) and the removably attached member (104) (not shown in FIG. 3 and FIG. 4) covering a magnifier lens (114).

In another embodiment of the present invention, the lighting source (106) of the touch sensitive lighting device (100) for is provided for illumination. The lighting source (106) of the touch sensitive lighting device (100) is housed on the fixed member (102) of the housing for the touch sensitive lighting device (100). The lighting source (106) of the touch sensitive lighting source (100) is a plurality of Light Emitting Diode (LED).

In another embodiment of the present invention, the power source (108) of the touch sensitive lighting device (100) is provided for powering the lighting source (106) for the touch sensitive lighting device (100) for illumination. The power source (108) of the touch sensitive lighting device (100) is housed in the fixed member (102) of the housing for the touch sensitive lighting device (100).

In another embodiment of the present invention, the touch sensitive contact point (110) (not shown in FIG. 4) is provided for controlling the lighting source (106) of the touch sensitive lighting device (100). The touch sensitive contact point (110) (not shown in FIG. 4) is comprising of a conductive material and terminally expended by a cosmetic chrome plat on the periphery of the fixed member (102) of the housing for the touch sensitive lighting device (100). The touch sensitive contact point (110) (not shown in FIG. 4) switches on the lighting source (106) of the touch sensitive lighting device (100) when the touch sensitive contact point (110) (not shown in FIG. 4) is touched by a single finger of a human being. The touch sensitive contact point (110) (not shown in FIG. 4) switches off the lighting source (106) of the touch sensitive lighting device (100) when the touch sensitive contact point (110) (not shown in FIG. 4) is released by a single finger of a human being. The touch sensitive contact point (110) (not shown in FIG. 4) of the touch sensitive lighting device (100) is localized on the fixed member (102) of the housing for the touch sensitive lighting device (100).

In another embodiment of the present invention, the circuit board (112) (not shown in FIG. 3 and FIG. 4) including circuitry is provided for controlling the lighting source (106) and the power source (108) of the touch sensitive lighting device (100). The circuit board (112) (not shown in FIG. 3 and FIG. 4) including circuitry for controlling the lighting source (106) and the power source (108) of the touch sensitive lighting device (100) is housed in the fixed member (102) of the housing for the touch sensitive lighting device (100).

In another embodiment of the present invention, a method of controlling a touch sensitive lighting device (100) is provided. The method of controlling a touch sensitive lighting device (100) comprising touching a touch sensitive contact point (110) of the touch sensitive lighting device (100) by a single finger of a human being; actuating circuitry of a circuit board (112); utilizing a power source (108) of the touch sensitive lighting device (100); switching on a lighting source (106) of the touch sensitive lighting device (100) for illumination; and releasing said touch sensitive contact point (110) of the touch sensitive lighting device (100) thereby switching off the lighting source (106) of the touch sensitive lighting device (100).

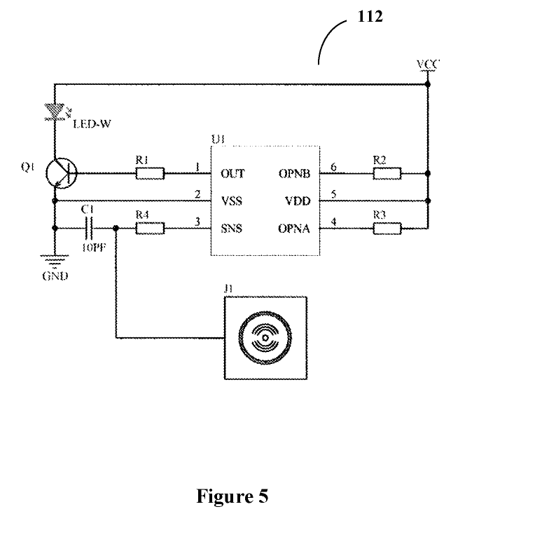

Referring to FIG. 5 is a circuit diagram of a circuit board of the touch sensitive lighting device.

In another embodiment of the present invention, the circuit board (112) includes circuitry for controlling the lighting source (106) (not shown in FIG. 5) and the power source (108) (not shown in FIG. 5) of the touch sensitive lighting device (100). The circuit board (112) including circuitry for controlling the lighting source (106) (not shown in FIG. 5) and the power source (108) (not shown in FIG. 5) of the touch sensitive lighting device (100) is housed in the fixed member (102) (not shown in FIG. 5) of the housing for the touch sensitive lighting device (100).

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1) A touch sensitive lighting device (100); characterized in having a touch sensitive contact point (110) for operating a lighting source (106) of the touch sensitive lighting device (100) with a single finger of a human being; the touch sensitive lighting device (100) comprising:
a. a housing for the touch sensitive lighting device (100); wherein said housing further comprising a fixed member (102) and a removably attached member (104);
b. the lighting source (106) of the touch sensitive lighting device (100) for illumination;
c. a power source (108) of the touch sensitive lighting device (100) for providing power to the lighting source (106) for the touch sensitive lighting device (100) for illumination;
d. the touch sensitive contact point (110) for controlling the lighting source (106) of the touch sensitive lighting device (100);
e. a circuit board (112) includes circuitry for controlling the lighting source (106) and the power source (108) of the touch sensitive lighting device (100); and
f. a magnifier lens (114).

2) The touch sensitive lighting device (100) of claim 1, wherein the lighting source (106) of the touch sensitive lighting device (100) is housed on the fixed member (102) of the housing for the touch sensitive lighting device (100).

3) The touch sensitive lighting device (100) of claim 1, wherein the lighting source (106) the touch sensitive lighting source (100) is a plurality of Light Emitting Diode (LED).

4) The touch sensitive lighting device (100) of claim 1, wherein the power source (108) of the touch sensitive lighting device (100) is housed in the fixed member (102) of the housing for the touch sensitive lighting device (100).

5) The touch sensitive lighting device (100) of claim 1, wherein the touch sensitive contact point (110) is comprising of a conductive material and terminally expended by a cosmetic chrome plat on the periphery of the fixed member (102) of the housing for the touch sensitive lighting device (100).

6) The touch sensitive lighting device (100) of claim 1, wherein the touch sensitive contact point (110) switches on the lighting source (106) of the touch sensitive lighting device (100) when the touch sensitive contact point (110) is touched by a single finger of a human being.

7) The touch sensitive lighting device (100) of claim 1, wherein the touch sensitive contact point (110) switches off the lighting source (106) of the touch sensitive lighting device (100) when the touch sensitive contact point (110) is released by a single finger of a human being.

8) The touch sensitive lighting device (100) of claim 1, wherein the touch sensitive contact point (110) of the touch sensitive lighting device (100) is localized on the fixed member (102) of the housing for the touch sensitive lighting device (100).

9) The touch sensitive lighting device (100) of claim 1, wherein the circuit board (112) including circuitry for controlling the lighting source (106) and the power source (108) of the touch sensitive lighting device (100) is housed in the fixed member (102) of the housing for the touch sensitive lighting device (100).

10) A method of controlling a touch sensitive lighting device (100); said method comprising;
a. touching a touch sensitive contact point (110) of the touch sensitive lighting device (100) by a single finger of a human being;
b. actuating circuitry of a circuit board (112);
c. utilizing a power source (108) of the touch sensitive lighting device (100);
d. switching on a lighting source (106) of the touch sensitive lighting device (100) for illumination;
e. releasing said touch sensitive contact point (110) of the touch sensitive lighting device (100) thereby switching off the lighting source (106) of the touch sensitive lighting device (100).
